(19) United States
(12) Patent Application Publication
(10) Pub. No.: US 2007/0122589 A1
(43) Pub. Date: May 31, 2007

(54) Workpiece fixing jig and working method making use of the jig

(75) Inventors: Yukihisa Takeuchi, Chita-gun (JP); Kenso Kanada, Chiryu-city (JP); Kazumasa Watanabe, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/602,702

(22) Filed: Nov. 21, 2006

(30) Foreign Application Priority Data
Nov. 28, 2005 (JP) 2005-341426
May 11, 2006 (JP) 2006-132153

(51) Int. Cl. B32B 3/10

(52) U.S. Cl. 428/131

(57) ABSTRACT

A workpiece fixing sheet comprises: a PET sheet as a base body; and a workpiece fixing agent coated on the PET sheet, for fixing a workpiece when the workpiece fixing agent is fused and coagulated according to a temperature, and a difference between a fusion start temperature and a fusion end temperature of the workpiece fixing agent is not more than 5° C.

### BACKGROUND OF THE INVENTION

1. Field of the Invention

The present invention relates to a workpiece fixing jig capable of strongly fixing a workpiece, which is to be worked, and allowing the workpiece to be easily removed after the completion of working. The present invention also relates to a working method making use of the workpiece fixing jig.

2. Description of the Related Art

When an object to be worked, which will be referred to as a workpiece hereinafter, and made of ceramic, clay, glass or metal, the shape of which is a plate-shape, a three-dimensional-deformed-shape or a thin-plate-shape, is worked, conventionally, the workpiece is stuck and fixed onto an adhesive tape and the workpiece is worked.

Concerning the adhesive tap for fixing the workpiece as described above, a heat peeling sheet, from which the workpiece can be removed when the workpiece is heated, is, provided. For example, this heat peeling sheet is made of PET in which a foaming agent, which can be foamed by heat, is mixed in a pressure sensitive adhesive agent. The foaming agent, which is mixed in the pressure sensitive adhesive agent, foams, for example, at 90° C., 120° C. or 150° C. Therefore, when the heat peeling sheet is heated to the above temperature after the workpiece has been worked, the foaming agent is expanded. Therefore, it becomes possible to remove the workpiece from the heat peeling sheet.

Apart from the above heat peeling sheet a PET sheet can be provided and a fixed workpiece can be removed from the sheet by irradiating ultraviolet rays onto the sheet. A component capable of reducing an adhesive force by irradiating hear infrared rays is mixed in the adhesive agent coated on the PET sheet. Therefore, when the PET sheet is irradiated with ultraviolet rays after the completion of working the workpiece, the adhesive force of the adhesive agent is reduced and-the workpiece can be removed from the sheet.

However, when the workpiece is removed from the adhesive tape, the adhesive agent is attached to the workpiece by the adhesive force of the adhesive agent. Therefore, even after the workpiece has been removed from the adhesive tape, there is a possibility that the adhesive agent can not be completely removed from the work. In this case, as the adhesive agent coated on the adhesive tape is made of an organic material, it is required that the workpiece is cleaned, for example, with an organic solvent such as-alcohol, acetone, benzene or toluene so as to remove the adhesive agent attached to the workpiece. However, in the case where the workpiece is made of material such as a ceramic which is easily attacked by an organic solvent, the workpiece is damaged when it is cleaned with the organic solvent. Further, in the case where the adhesive agent is removed with an organic solvent, it becomes complicated to handle, and dispose of, the organic solvent and the cost is raised.

For example, in the case where the thickness of the workpiece is not more than 1 mm when the workpiece is peeled from the adhesive sheet, there is a possibility that the workpiece is deformed or damaged by an adhesive force of the adhesive agent.

Even when it is possible to fix the workpiece with the adhesive agent which is a member for fixing the work, in the case where an adhesive force between a PET sheet and the adhesive agent is weak, the adhesive agent is peeled from the PET sheet in the process of working and it becomes impossible to conduct working.

### SUMMARY OF THE INVENTION

In view of the above points, it is a first object of the present invention to provide a workpiece fixing jig capable of easily removing a workpiece after the workpiece has been fixed and worked. It is also a first object of the present invention to provide a working method in which the workpiece fixing jig is used. It is a second object of the present invention to enhance an adhesive force between a PET sheet and a member for fixing the work.

In order to accomplish the above objects, the first characteristic of the present invention is that a difference between a fusion start temperature and a fusion end temperature of a workpiece fixing agent coated on a base body (11) is not more than 5° C.

As described above, a workpiece fixing jig is composed in such a manner that a workpiece fixing agent capable of completing fusion and coagulation in a temperature change of 5° C. or less is coated on a base body. Due to the foregoing, when the temperature is changed, the workpiece can be easily fixed to the workpiece fixing jig and, further, the workpiece can be easily peeled from the workpiece fixing jig. As described above, when the workpiece is fixed, an adhesive object is not used. Therefore, the workpiece can be easily removed.

In this connection, when the workpiece fixing agent is fused and coagulated while uniformly providing strong adhesion to a surface of the workpiece, the workpiece can be positively fixed to the workpiece fixing jig. Therefore, it is possible to prevent the workpiece from moving from the base body in the process of working. Accordingly, the workpiece can be highly accurately worked.

In this case, the fusion start temperature and the fusion end temperature of the workpiece fixing agent can be set in the range from 18° C. to 100° C.

When the temperature range is set as described above, the workpiece can be fixed according to the material of the workpiece to be worked.

A principal component of the workpiece fixing agent can be paraffin or polyethylene glycol.

As described above, the workpiece fixing agent is used, the principal component of which is paraffin or polyethylene glycol. When the purity of paraffin or polyethylene glycol is enhanced, it becomes possible to reduce a difference between the fusion start temperature and the fusion end temperature. Therefore, the difference between the fusion start temperature and the fusion end temperature can be made to be not more than 5° C. as described above.

Further, concerning paraffin, as shown in the following items (1) and (5), it is possible to use paraffin in which normal paraffin and non-normal paraffin are combined with each other. In this connection, percents of the rate of composition are all weight percents. As described before, it is preferable that the difference between the fusion start temperature and the fusion end temperature of paraffin is not more than 5° C. However, it is more preferable that the difference between the fusion start temperature and the fusion end temperature of paraffin is much smaller than that. In the following items, cases are shown in which the difference between the fusion start temperature and the fusion end temperature of paraffin is small.

(1) The total of normal paraffin components is 88.99% and the remainder is non-normal paraffin components.

“The Composition of Normal Paraffin”

Normal paraffin with carbon number 18: 0.08%
Normal paraffin with carbon number 19: 0.41%
Normal paraffin with carbon number 20: 1.76%
Normal paraffin with carbon number 21: 5.61%
Normal paraffin with carbon number 22: 10.66%
Normal paraffin with carbon number 23: 14.76%
Normal paraffin with carbon number 24: 14.50%
Normal paraffin with carbon number 25: 12.42%
Normal paraffin with carbon number 26: 9.08%
Normal paraffin with carbon number 27: 6.58%
Normal paraffin with carbon number 28: 4.04%
Normal paraffin with carbon number 29: 2.88%
Normal paraffin with carbon number 30: 2.09%
Normal paraffin with carbon number 31: 1.50%
Normal paraffin with carbon number 32: 1.02%
Normal paraffin with carbon number 33: 0.72%
Normal paraffin with carbon number 34: 0.37%
Normal paraffin with carbon number 35: 0.24%
Normal paraffin with carbon number 36: 0.14%
Normal paraffin with carbon number 37: 0.08%
Normal paraffin with carbon number 38: 0.05%

The total of the normal paraffin components is 88.99% and the remainder is non-normal paraffin components.

The average carbon number of paraffin of the above composition (1) is 24.74 and the standard deviation of the distribution of the molecular weight is 2.86. The smaller this standard deviation is, the narrower the molecular weight distribution becomes. In this composition (1), the maximum molecular weight of paraffin is 534 and the minimum molecular weight of paraffin is 254. Accordingly, the distribution width of the molecular weight is 280.

The fusion start temperature of paraffin of the composition (1) is 50.4° C. and the fusion end temperature is 51.7° C. Accordingly, it is possible to set the difference between the fusion start temperature and the fusion end temperature at 1.3° C. which is a low value. (2) The total of normal paraffin components is 88.64% and the remainder is non-normal paraffin components.

“The Composition of Normal Paraffin”

Normal paraffin with carbon number 18: 0.07%
Normal paraffin with carbon number 19: 0.28%
Normal paraffin with carbon number 20: 1.10%
Normal paraffin with carbon number 21: 3.38%
Normal paraffin with carbon number 22: 6.92%
Normal paraffin with carbon number 23: 10.86%
Normal paraffin with carbon number 24: 12.67%
Normal paraffin with carbon number 25: 12.74%
Normal paraffin with carbon number 26: 11.17%
Normal paraffin with carbon number 27: 9.18%
Normal paraffin with carbon number 28: 6.43%
Normal paraffin with carbon number 29: 4.73%
Normal paraffin with carbon number 30: 3.01%
Normal paraffin with carbon number 31: 2.16%
Normal paraffin with carbon number 32: 1.42%
Normal paraffin with carbon number 33: 0.98%
Normal paraffin with carbon number 34: 0.55%
Normal paraffin with carbon number 35: 0.36%
Normal paraffin with carbon number 36: 0.22%
Normal paraffin with carbon number 37: 0.15%
Normal paraffin with carbon number 38: 0.11%
Normal paraffin with carbon number 39: 0.09%
Normal paraffin with carbon number 40: 0.06%

The total of the normal paraffin components is 88.64% and the remainder is non-normal paraffin components.

The average carbon number of paraffin of the above composition (2) is 25.61 and the standard deviation of the distribution of the molecular weight is 3.05. In this composition (2), the maximum molecular weight of paraffin is 562 and the minimum molecular weight of paraffin is 254. Accordingly, the distribution width of the molecular weight is 366. The fusion start temperature of paraffin of the composition (2) is 52.5° C. and the fusion end temperature is 53.7° C. Accordingly, it is possible to set the difference between the fusion start temperature and the fusion end temperature at 1.2° C. which is a low value.

(3) The total of normal paraffin components is 89.57% and the remainder is non-normal paraffin components.

“The Composition of Normal Paraffin”

Normal paraffin with carbon number 19: 0.09%
Normal paraffin with carbon number 20: 0.34%
Normal paraffin with carbon number 21: 1.31%
Normal paraffin-with carbon number 22: 3.50%
Normal paraffin with carbon number 23: 7.09%
Normal paraffin with carbon number 24: 10.36%
Normal paraffin with carbon number 25: 12.57%
Normal paraffin with carbon number 26: 12.68%
Normal paraffin with carbon number 27: 11.75%
Normal paraffin with carbon number 28: 8.80%
Normal paraffin with carbon number 29: 6.99%
Normal paraffin with carbon number 30: 4.74%
Normal paraffin with carbon number 31: 3.41%
Normal paraffin with carbon number 32: 2.42%
Normal paraffin with carbon number 33: 1.70%
Normal paraffin with carbon number 34: 0.93%
Normal paraffin with carbon number 35: 0.54%
Normal paraffin-with carbon number 36: 0.25%
Normal paraffin with carbon number 37: 0.10%

The total of the normal paraffin components is 89.57% and the remainder is non-normal paraffin components.

The average carbon number of paraffin of the above composition (3) is 26.56 and the standard deviation of the distribution of the molecular weight is 2.94. In this composition (3), the maximum molecular weight of paraffin is 520 and the minimum molecular weight of paraffin is 268. Accordingly, the distribution width of the molecular weight is 252. The fusion start temperature of paraffin of the composition (3) is 54.6° C. and the fusion end temperature is 55.6° C. Accordingly, it is possible to set the difference between the fusion start temperature and the fusion end temperature at 1.0° C. which is a low value.

(4) The total of normal paraffin components is 71.11% and the remainder is non-normal paraffin components.

“The Composition of Normal Paraffin”

Normal paraffin with carbon number 23: 0.08%
Normal paraffin with carbon number 24: 0.16%
Normal paraffin with carbon number 25: 0.39%
Normal paraffin with carbon number 26: 0.87%
Normal paraffin with carbon number 27: 1.52%
Normal paraffin with carbon number 28: 1.99%
Normal paraffin with carbon number 29: 2.68%
Normal paraffin with carbon number 30: 3.14%
Normal paraffin with carbon number 31: 3.71%
Normal paraffin with carbon number 32: 3.94%
Normal paraffin with carbon number 33: 4.07%
Normal paraffin with carbon number 34: 4.37%
Normal paraffin with carbon number 35: 4.94%
Normal paraffin with carbon number 36: 5.49%
Normal paraffin with carbon number 37: 6.00%
Normal paraffin with carbon number 38: 5.44%
Normal paraffin with carbon number 39: 4.50%
Normal paraffin with carbon number 40: 3.71%
Normal paraffin with carbon number 41: 3.01%
Normal paraffin with carbon number 42: 2.53%
Normal paraffin with carbon number 43: 1.94%
Normal paraffin with carbon number 44: 1.55%
Normal paraffin with carbon number 45: 1.06%
Normal paraffin with carbon number 46: 0.84%
Normal paraffin with carbon number 47: 0.58%
Normal paraffin with carbon number 48: 0.45%
Normal paraffin with carbon number 49: 0.33%
Normal paraffin with carbon number 50: 0.32%
Normal paraffin with carbon number 51: 0.26%
Normal paraffin with carbon number 52: 0.21%
Normal paraffin with carbon number 53: 0.19%
Normal paraffin with carbon number 54: 0.17%
Normal paraffin with carbon number 55: 0.15%
Normal paraffin with carbon number 56: 0.13%
Normal paraffin with carbon number 57: 0.09%
Normal paraffin with carbon number 58: 0.09%
Normal paraffin with carbon number 59: 0.08%
Normal paraffin with carbon number 60: 0.06%
Normal paraffin with carbon number 61: 0.05%

The total of the normal paraffin components is 71.11% and the remainder is non-normal paraffin components.

The average carbon number of paraffin of the above composition (4) is 36.34 and the standard deviation of the distribution of the molecular weight is 5.70. In this composition (4), the maximum molecular weight of paraffin is 856 and the minimum molecular weight of paraffin is 324. Accordingly, the distribution width of the molecular weight is 532. The fusion start temperature of paraffin of the composition (4) is 72.1° C. and the fusion end temperature is 73.4° C. Accordingly, it is possible to set the difference between the fusion start temperature and the fusion end temperature at 1.3° C. which is a low value.

(5) The total of normal paraffin components is 75.78% and the remainder is non-normal paraffin components.

“The Composition of Normal Paraffin”

Normal paraffin with carbon number 29: 0.08%
Normal paraffin with carbon number 30: 0.23%
Normal paraffin with carbon number 31: 0.69%
Normal paraffin with carbon number 32: 1.36%
Normal paraffin with carbon number 33: 1.77%
Normal paraffin with carbon number.34: 2.02%
Normal paraffin with carbon number 35: 2.21%
Normal paraffin with carbon number 36: 2.41%
Normal paraffin with carbon number 37: 3.02%
Normal paraffin with carbon number 38: 3.58%
Normal paraffin with carbon number 39: 3.52%
Normal paraffin with carbon number 40: 3.94%
Normal paraffin with carbon number 41: 4.13%
Normal paraffin with carbon number 42: 5.15%
Normal paraffin with carbon number 43: 4.95%
Normal paraffin with carbon number 44: 5.54%
Normal paraffin with carbon number 45: 4.55%
Normal paraffin with carbon number 46: 4.71%
Normal paraffin with carbon number 47: 3.53%
Normal paraffin with carbon number 48: 3.08%
Normal paraffin with carbon number 49: 2.38%
Normal paraffin with carbon number 50: 2.16%
Normal paraffin with carbon number 51: 1.68%
Normal paraffin with carbon number 52: 1.35%
Normal paraffin with carbon number 53: 1.21%
Normal paraffin with carbon number 54: 1.00%
Normal paraffin with carbon number 55: 0.85%
Normal paraffin with carbon number 56: 0.80%
Normal paraffin with carbon number 57: 0.63%
Normal paraffin with carbon number 58: 0.59%
Normal paraffin with carbon number 59: 0.49%
Normal paraffin with carbon number 60: 0.41%
Normal paraffin with carbon number 61: 0.34%
Normal paraffin with carbon number 62: 0.38%
Normal paraffin with carbon number 63: 0.36%
Normal paraffin with carbon number 64: 0.30%
Normal paraffin with carbon number 65: 0.23%
Normal paraffin with carbon number 66: 0.15%

The total of the normal paraffin components is 75.78% and the remainder is non-normal paraffin components.

The average carbon number of paraffin of the above composition (5) is 43.69 and the standard deviation of the distribution of the molecular weight is 6.81. In this composition (5), the maximum molecular weight of paraffin is 926 and the minimum molecular weight of paraffin is 408. Accordingly, the distribution width of the molecular weight is 518. The fusion start temperature of paraffin of the composition (5) is 86.2° C. and the fusion end temperature is 87.9° C. Accordingly, it is possible to set the difference between the fusion start temperature and the fusion end temperature at 1.7° C. which is a low value.

Concerning polyethylene glycol, the following can be used. For example, with respect to polyethylene glycol, the mean molecular weight is 1540, the fusion start temperature is 46° C. and fusion end temperature is 47.2° C. Accordingly, it is possible to set the difference between the fusion start temperature and the fusion end temperature at 1.2° C. which is a low value.

Concerning polyethylene glycol, the mean molecular weight of which is 4000, the maximum molecular weight is 5464, the minimum molecular weight is 1689, the number mean molecular weight Mn is 2866, the weight mean molecular weight Mw is 2935, Z mean molecular weight Mz is 3004, and the molecular weight distribution dispersion Mw/Mn is 1.0238 and Mz/Mw is 1.0237. In this case, the closer to 1 the molecular weight distribution dispersion is, the narrower the distribution becomes. The fusion start temperature of this polyethylene glycol, the mean molecular weight of which 4000, is 55.1° C. and the fusion end temperature is 56.4° C. Accordingly, a difference between the fusion start temperature and the fusion end temperature can be set at 1.3° C. which is a low value.

Further, the base body can be formed into a sheet-shape body made of plastics, and the workpiece fixing jig can be composed in such a manner that one side or both sides of the sheet are coated with a workpiece fixing agent.

In this way, for example, a piece of foil or a fragile ceramic sheet can be easily strongly fixed so that it can be worked. Further, it can be easily removed as described above.

Concerning the above sheet-shaped base body, it is possible to use a sheet-shaped body, on the surface of which grooves (11a) are provided and the workpiece fixing agent is coated on the sheet-shaped body so that these grooves (11a) can be filled with the workpiece fixing agent.

When the grooves are provided on the sheet-shaped base body and the workpiece fixing agent is coated on the sheet-shaped base body so that these grooves can be filled with the agent, it is possible to extend an area of the portion in which the sheet-shaped base body and the workpiece fixing agent have strong adhesion to each other. Accordingly, the sheet-shaped base body and the workpiece fixing agent can have stronger adhesion to each other. That is, it is possible to prevent the workpiece fixing agent from being peeled off from the sheet-shaped base body.

The above grooves provided on the sheet-shaped base body can be formed when a surface of the base body is made to be rough with sand paper (#10 to #1000) or edged tools. Examples of the groove shape are a linear-shape, a curved-shape, a dotted-shape, a wave-shape, a cross-shape (grate-shape), an oblique-cross-shape (a shape of oblique lines) and a shape in which shapes in three directions are put on each other.

It is possible to compose a workpiece fixing jig in such a manner that an adhesive agent (13) or hot-melt-material is provided between the sheet-shaped base body and the workpiece fixing agent. When the adhesive agent or the hot-melt-material is coated on the sheet-shaped base body, the adhesive agent or the hot-melt-material has strong adhesion to the sheet-shaped base body. Therefore, the workpiece fixing agent can be prevented from being peeled off from the sheet-shaped base body. Concerning the adhesive agent, an acrylic adhesive agent may be used and bridged when it is irradiated with heat or ultraviolet rays. If the acrylic adhesive agent is not bridged, the coated material (workpiece fixing agent) and the adhesive agent are mixed with each other and it becomes impossible to attain the target function.

According to the structure in which the adhesive agent or the hot-metal-material is provided between the sheet-shaped base body and the workpiece fixing agent, at the time of removing the workpiece from the sheet-shaped base body after the completion of working, when hot water, the temperature of which is the fusing temperature at which only the workpiece fixing agent is fused, is poured, the workpiece can be easily removed from the workpiece fixing jig. Of course, it is possible to remove the workpiece when the workpiece fixing jig is heated to a temperature at which only the workpiece fixing agent is fused.

In this connection, when a coating material is mixed in the adhesive agent at the time of removing the workpiece from the workpiece fixing jig which-includes the adhesive agent and the hot-melt-material, the material, which is made to adhere, may be contaminated. This mixing of the coating material in the adhesive agent is not desirable. Accordingly, it is preferable that the heating is conducted at a temperature at which only the workpiece fixing agent is fused.

According to the second characteristic of the present invention, a workpiece (40) is put on a workpiece fixing jig (10) coated with a workpiece fixing agent (12) which is fused or coagulated over a difference in the temperature of 5° C. The workpiece fixing jig (10) is heated to a fusion end temperature so as to fuse the workpiece fixing agent (12). Then the temperature of the workpiece fixing jig is lowered to a fusion start temperature so as to coagulate the workpiece fixing agent. Then, a workpiece is subjected to working. After the completion of working, the workpiece fixing jig is heated to a fusion end temperature and then the workpiece is removed from the workpiece fixing jig.

As described above, the workpiece is fixed by the workpiece fixing agent in which fusion and coagulation can be completed by the temperature change of 5° C. or less. Due to the foregoing, when the temperature of the workpiece fixing jig, that is, the temperature of the workpiece fixing agent is changed, the workpiece can be easily fixed to the workpiece fixing jig. As the workpiece is strongly fixed to the workpiece fixing agent in this state, there is no possibility that the workpiece is moved from the base body. Accordingly, the workpiece can be highly accurately worked.

It is possible to fix the workpiece to the workpiece fixing jig when the workpiece fixing agent is fused and coagulated according to the temperature. Therefore, the workpiece made of fragile material can be easily fixed and worked. Further, as the workpiece fixing agent is fused and completely removed from the workpiece at the time of removing the workpiece from the workpiece fixing jig, for example, when hot water is poured, the workpiece fixing agent can be easily peeled off from the workpiece.

In the manner described above, at the time of working the work, the above workpiece fixing jig can be used.

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

In the drawings:

FIG. 1 is a plan view showing a workpiece fixing sheet of the first embodiment of the present invention;

FIG. 2 is a view showing circumstances of manufacturing the workpiece fixing sheet shown in FIG. 1;

FIG. 3 is a view showing circumstances of working a workpiece which is fixed onto a workpiece fixing sheet;

FIG. 4 is a plan view showing a workpiece fixing sheet of the second embodiment of the present invention;

FIG. 5 is a view showing circumstances of manufacturing the workpiece fixing sheet shown in FIG. 4;

FIG. 6A is a plan view of a PET sheet, on the surface of which grate-shaped grooves are formed, of the third embodiment of the present invention;

FIG. 6B is a plan view of a PET sheet, on the surface of which wave-shaped grooves are formed, of the third embodiment of the present invention;

FIG. 6C is a plan view of a PET sheet, on the surface of which oblique-line-shaped grooves are formed, of the third embodiment of the present invention;

FIG. 7 is a sectional view taken on line A-A in FIG. 6A;

FIG. 8A is a plan view showing a workpiece fixing sheet of the fourth embodiment of the present invention;

FIG. 8B is a sectional view taken on line B-B in FIG. 8A;

FIG. 9 is a plan view showing a workpiece fixing sheet formed in such a manner that a dot-shaped workpiece fixing agent is coated on a PET sheet in another embodiment; and

FIG. 10 is a view showing a workpiece fixing sheet of the sixth embodiment of the present invention.

### DESCRIPTION OF THE PREFERRED EMBODIMENTS

Embodiments of the present invention will be explained below referring to the drawings. In this connection, in the embodiments described as follows, like reference characters are used to indicate like parts.

First of all, the first embodiment will be explained below. On a workpiece fixing sheet of the present embodiment, a workpiece to be worked, which is made of ceramic, clay, glass, metal (aluminum, iron, copper, brass and so forth) or resin, is fixed by a fixing agent which is fused or coagulated when it is heated to a predetermined temperature.

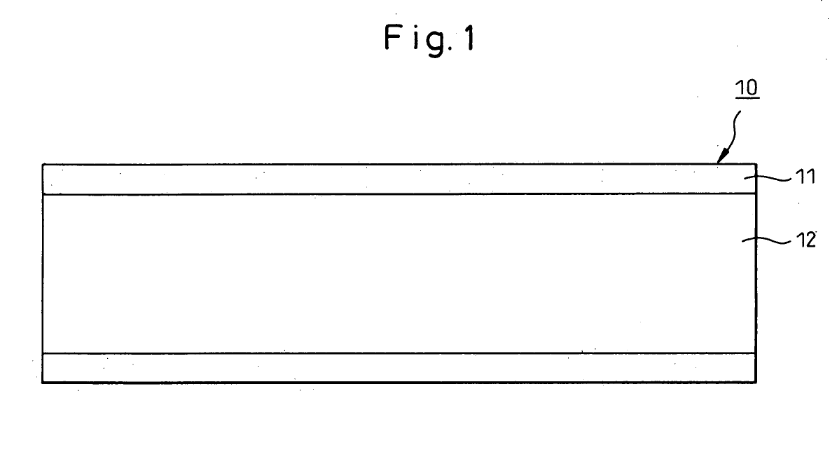

FIG. 1 is a plan view showing a workpiece fixing sheet, which is a workpiece fixing jig, of the first embodiment of the present invention. As shown in the drawing, the workpiece fixing sheet 10 includes: a PET sheet 11 which is a base body; and a workpiece fixing agent 12 coated on the PET sheet 11. In this connection, in the present embodiment, the workpiece fixing agent 12 is coated on one side of the PET sheet 11, however, both faces of the PET sheet 11 may be coated with the workpiece fixing agent 12.

The PET sheet 11 is a sheet made of resin such as polyester. As shown in FIG. 1, in the present embodiment, the PET sheet 11 is rectangular. For example, a length in the longitudinal direction is 15 cm and a width is 10 cm. For example, the thickness of the PET sheet 11 is 100 μm. In this connection, it is preferable that the PET sheet 11 can withstand a temperature at which the workpiece fixing agent 12 is fused.

The workpiece fixing agent 12 is used for fixing the workpiece. The principal component of the workpiece fixing agent 12 is paraffin. As shown in FIG. 1, the workpiece fixing agent 12 is uniformly coated and solidified on the PET sheet 11. The thickness of the workpiece fixing agent 12 can be freely designed. For example, the thickness of the workpiece fixing agent 12 can be less than 3 μn. In this connection, the terminology that the principal component of the workpiece fixing agent 12 is paraffin includes that the workpiece fixing agent 12 is made only of paraffin.

Concerning the workpiece, for example, in the case of cutting raw PZT (piezoelectric zirconate titanate), a workpiece fixing agent 12, in which a content of paraffin is 40 to 100 weight % and a content of alumina (particle diameter: nano particle size to several mm) is 0 to 60 weight %, is suitably used.

In another case in which a conductive sheet is cut, a workpiece fixing agent 12, in which a content of paraffin is 40 to 99 weight % and a content of carbon (conductive carbon material, particle diameter: nano particle size to several mm) is 1 to 60 weight %, is suitably used.

In the present embodiment, the composition of the workpiece fixing agent is the composition (2). That is, a temperature range, in which the workpiece fixing agent 12 is fused and coagulated, is 2° C. to 5° C. Therefore, when a heating temperature of heating the workpiece fixing agent 12 is changed only by 1.2° C., the workpiece fixing agent 12 can be easily fused and coagulated. In this connection, it is preferable that the workpiece fixing agent 12 is fused and coagulated over a small difference in temperature.

Accordingly, the workpiece fixing agent 12 is coagulated and attached onto the PET sheet 11 at a room temperature (for example, 27° C.). In the case where the workpiece fixing sheet 10 is heated to a temperature not less than the fusion point of the workpiece fixing agent 12, the workpiece fixing agent 12 is fused when the temperature is raised to be higher than the fusion point by only 1.2° C. When the temperature is decreased to be lower than the fusion point, the workpiece fixing agent 12 is coagulated.

Detailed explanations will be made into a method of working a workpiece as follows. In the present embodiment, the workpiece is fixed onto the workpiece fixing sheet 10 and then worked. After that, hot water, the temperature of which is approximately 100° C., is poured onto the workpiece fixing sheet 10 and then the workpiece fixing agent 12 is fused and the workpiece is removed from the workpiece fixing sheet 10. At room temperature (27° C.), the workpiece fixing agent 12 is coagulated onto the PET sheet 11, so that it can be easily carried and preserved. Therefore, in the present embodiment, a fusion point of the workpiece fixing agent 12 is set at a temperature higher than the room temperature and lower than the temperature of hot water, that is, the fusion point of the workpiece fixing agent 12 is set at 53° C.

When an additive agent, which maintains paraffin material in a complete fusion state, is put into hot water, it is possible to avoid the occurrence of a phenomenon that the workpiece fixing agent 12 coagulates and floats on water and a film is formed on the water surface. In this case, the additive agent functions in such a manner that the additive agent dissolves the paraffin in hot water and maintaining the dissolving state in the hot water even after the temperature is decreased.

The aforementioned difference between the fusion start temperature and the fusion end temperature can be set according to a distribution of the molecular weight of paraffin contained in the workpiece fixing agent 12. In other words, the aforementioned difference between the fusion start temperature and the fusion end temperature can be set according to the purity of paraffin contained in the workpiece fixing agent 12. Paraffin material can be described by the molecular formula CₙHₘ (n, m: an arbitrary integer). In the case of material which is fused at a low temperature, C is a small number, that is, n is a small number. When C is a large number, the fusion temperature is raised. When material, the number of C of which is large, and material, the number of C of which is small, are mixed with each other, the fusion temperature is distributed in a range. Regarding the purity of paraffin material fused at a low temperature, for example, in the case where it is necessary for it to be fused at a temperature close to the room temperature by the temperature difference 2° C., paraffin material, the molecular weight distribution range is approximately 50 to 3000, is used. Regarding the purity of paraffin material fused at a temperature close to 50° C., paraffin material, the molecular weight distribution range of which is approximately 100 to 10000, is used. In the purity of paraffin material fused at a temperature close to 90° C., it is preferable that a molecular weight distribution range is approximately 500 to 100000.

In order to reduce a distribution range of the molecular weight, material is refined. When refining is highly accurately conducted, the molecular weight distribution range can be reduced. However, when the molecular weight distribution range is reduced, the amount of the material obtained by refining is decreased. As a result, the yield is deteriorated and the manufacturing cost is raised.

When the molecular weight distribution range is reduced, the purity is enhanced. At the same time, the range of the fusion temperature is reduced. Therefore, it is possible to fuse and coagulate in a narrow temperature range.

Inorganic powder material such as alumina, carbon, iron, SUS (stainless steel), SiC, Si or silicon nitride may be mixed in the workpiece fixing agent such as paraffin. Due to the foregoing, as described later, in the case where a workpiece is cut off with a diamond cutter, the workpiece fixing agent is continuously and linearly cracked. Therefore, it is possible to prevent a cut piece from being shifted from a predetermined position. That is, when the inorganic powder material exists in the workpiece fixing agent being dispersed, the inorganic powder material fulfills a function of stopping an extension of the linear crack.

When the inorganic powder material is dispersed in the workpiece fixing agent, in the case where the work is cut off with a grinding tool or a cutting tool, it is possible to prevent deterioration of the grinding property and cutting property of the workpiece caused when the workpiece fixing agent is accumulated on the grinding and the cutting face. That is, when the inorganic powder material comes into contact with the grinding and the cutting face, the workpiece fixing agent can be peeled off from the grinding and the cutting face concerned.

In this connection, a particle size of the inorganic powder material is from a nano unit size to several millimeters.

For example, in the case of fixing a raw sheet of PZT, as described before, it is appropriate to use a workpiece fixing agent in which a content of paraffin is 40 to 100 weight % and a content of alumina (particle size: nano particle size to several mm) powder is 0 to 60 weight %.

In the case where hardness is required, it is appropriate to use a workpiece fixing agent in which a content of paraffin is 40 to 100 weight % and a content of SiC (particle size: nano particle size to several mm) powder is 0 to 60 weight %.

In the case where metallic material is fixed, it is appropriate to use a workpiece fixing agent in which a content of paraffin is 0 to 100 weight % and a content of SUS (particle size: nano particle size to several mm) powder is 0 to 60 weight %.

In the case where glass is fixed, it is appropriate to use a workpiece fixing agent in which a content of paraffin is 40 to 100 weight % and a content of glass (particle size: nano particle size to several mm) powder is 0 to 60 weight %.

In the case where a ceramic baked material is fixed, it is appropriate to use a workpiece fixing agent in which a content of paraffin is 40 to 100 weight % and a content of the same material as that of fixing material (particle size: nano particle size to several mm) powder is 0 to 60 weight %.

In the case where paper is fixed, it is appropriate to use a workpiece fixing agent in which a content of paraffin is 100 weight %.

Concerning the above workpiece fixing agent 12, Katameru Chakku (brand name, American registered trade mark Thermofix) can be used. The constitution of the workpiece fixing sheet 10 of the present embodiment has been described above.

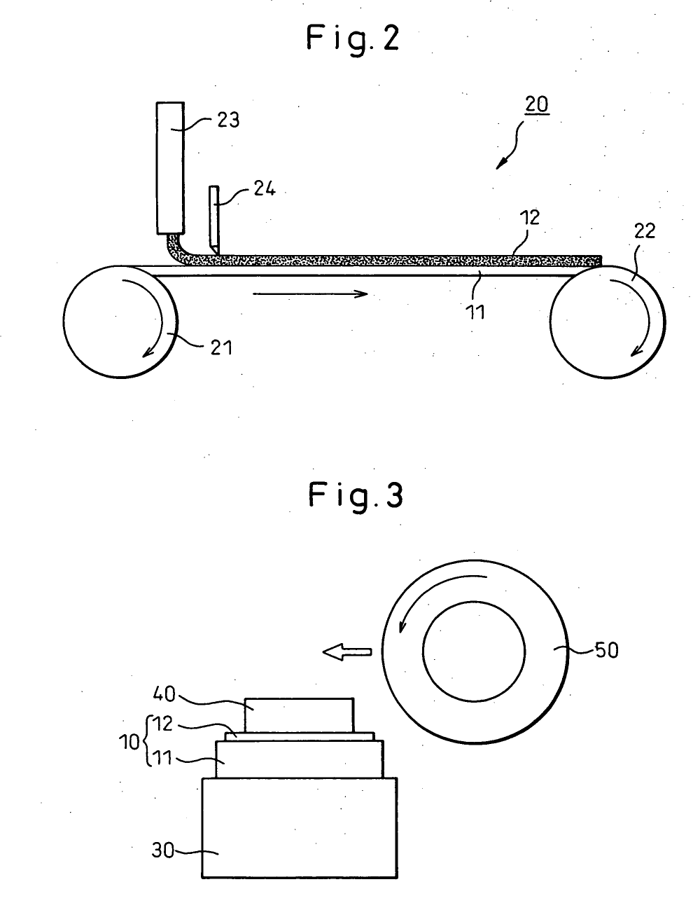

Next, referring to the drawing, a method of manufacturing the above workpiece fixing sheet 10 will be explained below. FIG. 2 is a view showing circumstances of manufacturing the workpiece fixing sheet 10.

First of all, explanations will be made into a coating device 20 for manufacturing a workpiece fixing sheet 10. As shown in FIG. 2, the coating device 20 includes: a delivery roller 21; a winding roller 22; a roller drive unit not shown for driving the rollers 21, 22; a nozzle 23 for coating fused workpiece fixing agent 12 on a PET sheet 11; a nozzle drive unit not shown for driving the nozzle 23; a bank member 24 for checking the workpiece fixing agent 12 which has been fused and injected from the nozzle 23 so that the thickness of the workpiece fixing agent 12 can be adjusted; and a height adjustment device not shown for adjusting a height of the bank member 24.

The PET sheet 11, the thickness of which is, for example, 100 μm, is prepared. This PET sheet 11 is wound around the delivery roller 21. This delivery roller 21 is arranged in the coating device 20. Then, as shown in FIG. 2, the PET sheet 11 is wound around the winding roller 22. In order-to set a gap, which is formed between a surface of the PET sheet 11 and a forward end portion of-the bank member 24, at a thickness of the workpiece fixing agent 12, a height of the bank member 24 from the PET sheet 11 is adjusted to be a predetermined height. When the height of the bank member 24 is adjusted as described above, it is possible to form a workpiece fixing agent 12, the thickness of which is several μm to 3 mm.

The surface temperature of the PET sheet 11, onto which the fused work fixing agent 12 is coated, is heated to a temperature not less than the fusion point. In this connection, the delivery roller 21 may be heated to a temperature (a temperature not less than 53° C. in the present embodiment) higher than the fusion point of the workpiece fixing agent 12. In order to wind the PET sheet 11 around the winding roller 22 while the fused workpiece fixing agent 12 is being coagulated, it is preferable that a temperature of the winding roller 22 is decreased to be lower than the fusion point of the workpiece fixing agent 12.

After that, when the rollers 21, 22 are respectively driven, the PET sheet 11 is delivered from the delivery roller 21 and wound around the winding roller 22 at the same time. In the above circumstances, the workpiece fixing agent 12 is heated to a temperature not less than the fusion point and the workpiece fixing agent 12 is injected from the nozzle 23 onto the PET sheet 11. The fused workpiece fixing agent 12, which has been injected onto the PET sheet 11, is moved together with the PET sheet 11 which is being delivered. At this time, the workpiece fixing agent 12 is checked by the bank member 24. Therefore, the workpiece fixing agent 12, the thickness of which is the same as the gap formed between the PET sheet 11 and the forward end portion of the bank member 24, is moved together with the PET sheet 11. In this way, the workpiece fixing agent 12 is coated on the PET sheet 11.

The fused workpiece fixing agent 12 is cooled to a temperature not more than the fusion point and coagulated on the PET sheet 11 before it is wound around the winding roller 22. Then, the workpiece fixing agent 12 is wound around the winding roller 22 together with the PET sheet 11. As described above, the workpiece fixing agent 12 is sharply changed between the states of fusion and coagulation in the small range from 2° C. to 5° C. Accordingly, it is unnecessary to provide a device for cooling and solidifying the fused workpiece fixing agent 12. The fused workpiece fixing agent 12 is cooled to a temperature not more than the fusion point and coagulated in the process of winding the PET sheet 11. That is, it is sufficient that only the side, on which the workpiece fixing agent 12 is injected, that is, only the nozzle 23 side is heated to a temperature not less than the fusion point of the workpiece fixing agent 12. As the thus coagulated workpiece fixing agent 12 is strongly fixed onto the PET sheet 11, even when the coagulated workpiece fixing agent 12 is wound around the winding roller 22 together with the PET sheet 11, it is not peeled off from the PET sheet 11. Further, as the workpiece fixing agent 12 is not adhesive, even when the workpiece fixing sheet 10 is wound around the winding roller 22, there is no possibility that the workpiece fixing agent 12 is stuck onto the PET sheet 11.

Next, when the PET sheet 11, which is wound around the winding roller 22, is cut off at predetermined intervals, the workpiece fixing sheet 10 shown in FIG. 1 is completed.

Next, referring to the drawings, a method of fixing a workpiece by making use of the workpiece fixing sheet 10 manufactured as described above will be explained. Further, a method of working the workpiece will be explained. FIG. 3 is a view showing circumstances in which the workpiece is fixed to the workpiece fixing sheet 10 and worked.

First of all, the workpiece fixing sheet 10 is arranged on the base 30. Then the workpiece 40 is put on the workpiece fixing sheet 10. Examples of the material of the workpiece 40 which is to be worked are ceramic, clay, glass, metal (aluminum, iron, copper, brass and so forth) and resin. Examples of the shape of the workpiece 40 are a plate-shape, a sheet-shape and a three-dimensionally-deformed-shape. As long as it can be set on the workpiece fixing sheet 10, any workpiece may be used here. In this connection, examples of the sheet-shaped workpiece are a raw sheet made of ceramic, a raw sheet made of glass, a raw sheet of piezo, a raw sheet of condenser and an object in which these sheets are laminated on each other.

Next, the base 30 is heated by a heater, not shown. In the present embodiment, it is preferable that the base 30 is heated to a temperature in the range from 55° C. to 58° C. which is the fusion end temperature of the workpiece fixing agent 12. When the fixing sheet 10 is heated through the base 30 as described above, the workpiece fixing agent 12 is fused. Therefore, the fused workpiece fixing agent 12 closely adheres onto a surface of the workpiece 40.

After that, when the base 30 is cooled to a temperature not more than the fusion point, the workpiece fixing agent 12 is coagulated and the workpiece 40 is fixed onto the workpiece fixing sheet 10. In the case where the thickness of the workpiece fixing agent 12 is, for example, 5 μm, the adhesion strength of the workpiece fixing agent 12 is 7 kgf/cm² to 20 kgf/cm². Therefore, the workpiece 40 can be strongly fixed.

Even a three-dimensional-deformed workpiece 40, the surface of which protruded and recessed, can be strongly fixed. That is, in the case where the workpiece fixing agent 12 is solid, only the protruding portions of the workpiece 40 come into contact with the workpiece fixing agent 12. However, when the workpiece fixing agent 12 is fused, it can be made to get into the recessing portions of the workpiece 40. Due to the foregoing, when the workpiece fixing agent 12 is solidified, the workpiece fixing agent 12 can be uniformly contacted on a surface of the workpiece 40 to be fixed. Therefore, it is possible to obtain a strong fixing force. That is, irrespective of the shape of the surface of the workpiece 40, the workpiece 40 can be strongly fixed.

As the workpiece fixing agent 12 is completely solidified at this time, the workpiece 40 can be perfectly fixed onto the workpiece fixing sheet 10, that is, the workpiece 40 can be positively fixed. Accordingly, this structure is characterized in that even when the workpiece 40 is cut off at minute intervals (for example, at intervals of 0.1 mm) the work 40 is not moved.

After the workpiece 40 has been fixed onto the workpiece fixing sheet 10 as described above, the workpiece 40 is worked. In the present embodiment, the workpiece 40 is cut off with a diamond grinding stone 50, the thickness of which is 0.3 mm, rotating at a rotary speed of 2,700 rpm. At this time, the workpiece fixing agent 12 is also cut off together with the workpiece 40. In the present embodiment, when the workpiece 40 is cut off with the diamond grinding stone 50, the PET sheet 11 is not completely cut off but only the surface of the PET sheet 11 is cut off. However, no problems are caused even when the PET sheet 11 is also completely cut off together with the workpiece 40.

The working to be conducted on the workpiece 40 is not limited to the above cutting. For example, it is possible to conduct the working of grinding, polishing, drilling or machining with a knife.

After the workpiece 40 has been worked, it is removed from the workpiece fixing sheet 10. Specifically, the workpiece 40 is removed from the workpiece fixing sheet 10 as follows. As the workpiece fixing agent 12 is fused or coagulated according to a temperature, when hot water, the temperature of which is higher than the fusion end temperature (55° C. to 58° C.) of the workpiece fixing agent 12, is poured onto the workpiece 40, the workpiece fixing agent 12, which has tightly adhered onto the workpiece 40, is peeled off. In this connection, the workpiece 40 may be dipped in the hot water. In this case, when a surface active agent is introduced into the hot water, the workpiece fixing agent 12 can be dissolved in a water solution.

When the workpiece fixing agent 12 is peeled off as described above, as the specific gravity of the workpiece fixing agent 12 is lower than that of water and, for example, as the specific gravity of the workpiece fixing agent 12 is 0.8 to 0.9, the workpiece fixing agent 12 floats on water (hot water). Therefore, the workpiece 40 can be easily cleaned. In this connection, in order to facilitate the cleaning effect, it is possible to use an ultrasonic cleaning method or hyper-fine foam cleaning method. Further, it is possible to use a method of introducing detergent into the cleaning water solution.

As described above, the working of the workpiece 40 is completed. When the workpiece fixing agent 12, which has been removed from the workpiece 40, is recovered and recycled or reused, the workpiece fixing agent 12 can be utilized many times. In this connection, in the cutting work shown in FIG. 3, a surface of the PET sheet 11 is scraped with the diamond grinding stone 50. Therefore, it is impossible to reuse the PET sheet 11. However, concerning the workpiece fixing agent 12 attached to the workpiece 40 and the PET sheet 11, when the workpiece fixing agent 12 is fused and recovered, it can be recycled and reused. When the workpiece fixing agent 12 is formed into a large thickness and cut off together with the workpiece 40 without cutting off the PET sheet 11, the PET sheet 11 may be reused.

As explained above, in the present invention, the workpiece fixing sheet 10, which is a workpiece fixing jig, is composed of the PET sheet 11, which is a base body and on which the workpiece fixing agent 12 is coated, in which fusion and coagulation can be completed by a change in the temperature not more than 5° C. Due to the above structure, when the temperature of the workpiece fixing sheet 10 is changed by at least 5° C., the workpiece fixing sheet 10 and the workpiece 40 can be easily fixed to each other. In the same manner, when the temperature of the workpiece fixing sheet 10 is changed by at least 5° C., the workpiece 40 can be easily peeled off from the workpiece fixing sheet 10. In the case of peeling in this way, when hot water is poured as described above, the workpiece fixing agent 12 can be easily removed from the workpiece 40. In this connection, when a dispersion agent is put into the hot water, paraffin can be dispersed into the solution. Unless the dispersion agent is put into the hot water, when the solution is cooled to a temperature not more than the fusion temperature, paraffin floats onto the solution surface and solidifies and a film of paraffin is formed. Therefore, this work needs care.

Conventionally, a workpiece is fixed by an adhesive agent coated on a heat peeling sheet or PET sheet. However, as the adhesive agent is not perfectly solidified, for example, at the time of working a workpiece with a rotating grinding stone, when an edge of the grinding stone comes into contact with the workpiece, the workpiece is moved. Especially when a cutting width of the workpiece is small, the workpiece is greatly moved when the edge of the grinding stone comes into contact with the workpiece. Due to the foregoing, there is a possibility that it is impossible to highly accurately work the workpiece. However, according to the present embodiment, when the workpiece fixing agent 12 is fused and coagulated while uniformly adhering onto the surface of the workpiece 40, the workpiece 40 can be strongly fixed onto the workpiece fixing sheet 10. Therefore, it is possible to prevent the workpiece 40 from being moved from the workpiece fixing sheet 10. Accordingly, the workpiece 40 can be highly accurately worked.

Further, as described above, according to the present embodiment, the workpiece 40 is not fixed with an adhesive agent, unlike in the conventional manner. In the present embodiment, the workpiece fixing agent 12, which repeats fusion and coagulation in a small difference in temperature (2° C. to 5° C.), is used. Therefore, unlike the adhesive tape, which becomes a base body, on which the adhesive agent is coated, the material is not limited to a specific material. In the present embodiment, the PET sheet 11 is used for the base body.

Next, a second embodiment will be explained below. In the present embodiment, only points different from those of the first embodiment will be explained. On the workpiece fixing sheet 10 of the present embodiment, a coating pattern of the workpiece fixing agent 12 coated on a PET sheet is formed into a stripe-shape.

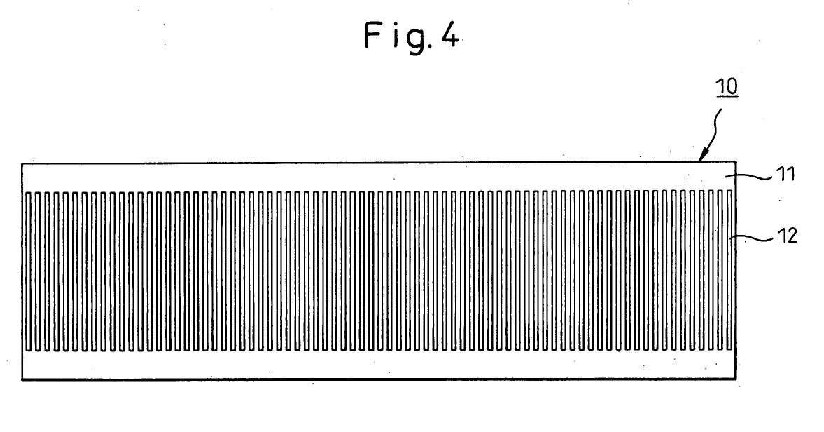

FIG. 4 is a plan view showing a workpiece fixing sheet of the second embodiment of the present invention. As shown in the drawing, on the workpiece fixing sheet 10 of the present embodiment, the workpiece fixing agent 11 is coated into a stripe-shape on a PET sheet 11 and solidified. A width of each stripe of-the workpiece fixing agent 11 can be freely designed. For example, it is preferable to design in such a manner that the width is 0.05 mm to several tens mm, the interval is 0.1 mm to several mm and the direction of the stripe is in the longitudinal or lateral direction.

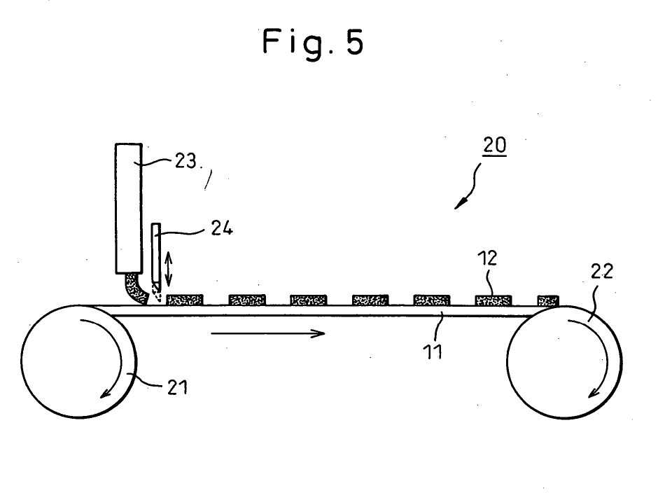

FIG. 5 is a view showing circumstances of manufacturing the workpiece fixing sheet 10 shown in FIG. 4. In the present embodiment, in the coating device 20, when a height adjustment device not shown for adjusting a height of the bank member 24 drives the bank member 24, a forward end portion of the bank member 24 is contacted with or separated from the PET sheet 11 in a predetermined period. Due to the foregoing, as shown in FIG. 5, portions in which the workpiece fixing agent 12 is coated and portions in which the workpiece fixing agent 12 is not coated are provided on the PET sheet 11. Accordingly, the stripe-shaped workpiece fixing agent 12 shown in FIG. 4 can be formed.

When the stripe-shaped workpiece fixing agent 12 is formed on the PET sheet 11 as described above, even if the PET sheet 11 is bent or wound, the workpiece fixing agent 12 is not peeled off from the PET sheet 11 by the stress generated in the workpiece fixing agent 12. In this way, a layout of the workpiece fixing agent 12 can be freely changed.

Next, the third embodiment will be explained below. In the present embodiment, only points different from those of the embodiments described before will be explained. The present embodiment is characterized in that grooves are formed on the PET sheet 11 composing the workpiece fixing sheet 10.

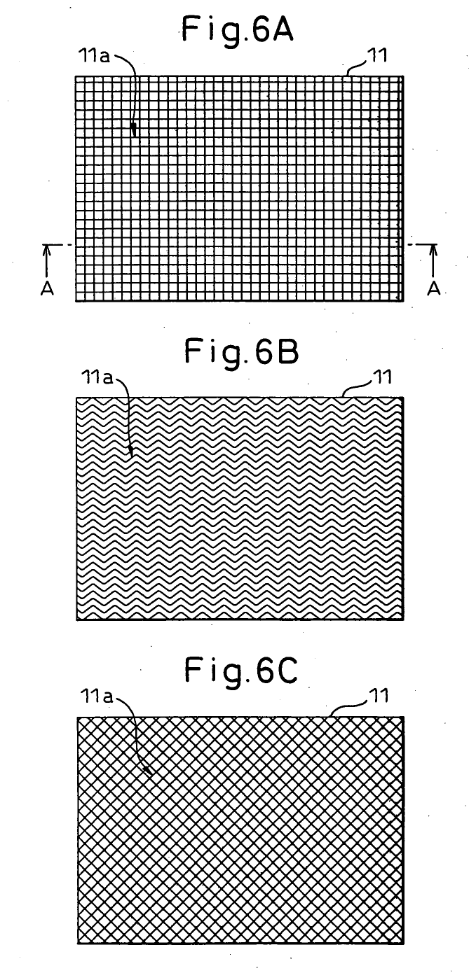

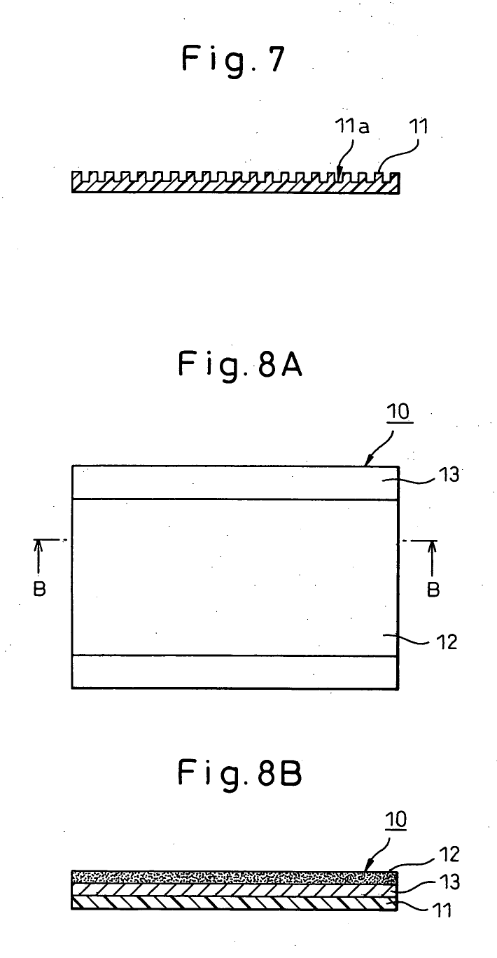

FIGS. 6A to 6C are plan views of a PET sheet 11 of the third embodiment of the present invention. FIG. 7 is a sectional view taken on line A-A in FIG. 6A.

On the PET sheet 11 shown in FIG. 6A, when grooves are formed in the longitudinal direction and in the direction perpendicular to the longitudinal direction, grate-shaped grooves 11a are formed. In the present embodiment, as shown in FIG. 7, the grooves 11a are formed on one side of the PET sheet 11. Depth of the groove 11a is, for example, 1 μm to 500 μm.

These grooves 11a are formed when one side of the PET sheet 11 is made to be rough, for example, with sand paper (for example, #10 to #100). That is, when one side of the PET sheet 11 is rubbed with sand paper in the longitudinal direction and in the-direction perpendicular to the longitudinal direction, the grate-shaped grooves 11a shown in FIG. 6A are formed.

On the PET sheet 11 shown in FIG. 6B, the wave-shaped grooves 11a are formed in the longitudinal direction of the PET sheet 11. Further, on the PET sheet 11 shown in FIG. 6C, the oblique-line-shaped-grooves 11a are formed in the direction of 45° with respect to the longitudinal direction of the PET sheet 11.

In the same manner as that of using sand paper described before, the grooves 11a of the PET sheets 11 shown in FIGS. 6B and 6C are formed when surfaces of the PET sheets 11 are rubbed with sand paper so that a wave-shaped pattern or oblique-line-shaped pattern can be formed.

Specifically, the grooves 11a are formed on one side of the PET sheet 11 in such a manner that sand paper is wound around a roller and then this roller is rotated and rubbed onto a surface of the PET sheet 11.

That is, when the roller, around which sand paper is wound, is rotated and rubbed onto one side of the PET sheet 11 in the longitudinal direction and in the direction perpendicular to the longitudinal direction, the grate-shaped grooves 11a shown in FIG. 6A can be formed on the PET sheet 11.

When the roller, around which sand paper is wound, is driven in axial direction of the roller and at the same time the roller is rotated and sand paper is rubbed onto the PET sheet 11, the wave-shaped grooves 11a shown in FIG. 6B can be formed on the PET sheet 11.

Further, when the roller, around which sand paper is wound, is rotated so that a relation can be maintained in which an angle formed between the axial direction of the roller and the longitudinal direction of the PET sheet 11 is an acute angle or obtuse angle, and sand paper is rubbed onto the PET sheet 11, the oblique-line-shaped grooves 11a shown in FIG. 6C can be formed on the PET sheet 11.

In this connection, sand paper may not be wound around the-roller and a surface of the PET sheet 11 may be directly made to be rough with sand paper.

After the grooves 11a have been formed on the PET sheet 11, when the fused workpiece fixing agent 12 is coated on the PET sheet 11 by the methods shown in FIGS. 2 and 5, the workpiece fixing sheets 10 shown in FIGS. 1 and 4 are formed.

As explained above, when the grooves 11a are provided on the PET sheet 11, a surface area on one side of the PET sheet 11 is ensured. When the workpiece fixing agent 12 is coated on the PET sheet 11 so that these grooves 11a can be filled with the workpiece fixing agent 12, a contact area of one side of the PET sheet 11 with the workpiece fixing agent 12 can be ensured and the adhesion force of the PET sheet 11 to the workpiece fixing agent 12 can be enhanced. Due to the foregoing, a fixing force of fixing the PET sheet 11 to the workpiece fixing agent 12 can be enhanced. Therefore, it is possible to prevent the workpiece fixing agent 12 from being peeled off from the PET sheet 11.

Next, the fourth embodiment will be explained below. In the present embodiment, only points different from those of the embodiments described before will be explained. The present embodiment is characterized in that, in order to enhance an adhesion force of the PET sheet 11 to the workpiece fixing agent 12, the adhesive agent 13 is provided between the PET sheet 11 and the workpiece fixing agent 12.

FIG. 8A is a plan view showing a workpiece fixing sheet 10 of the fourth embodiment of the present invention. FIG. 8B is a sectional view taken on line B-B in FIG. 8A.

As shown in FIG. 8B, the workpiece fixing sheet 10 of the present embodiment includes: the PET sheet 11; an adhesive agent 13 coated on the PET sheet 11; and a workpiece fixing agent 12 coated on the adhesive agent 13.

The adhesive agent 13 strongly fixes the workpiece fixing agent 12 onto the PET sheet 11. Examples of the adhesive agent 13 are acrylic paste, cellulose paste and epoxy paste. The adhesive agent 13 is uniformly coated on the PET sheet 11 by the thickness of, for example, 1 μm to 200 μm.

As shown in FIG. 8A, the above adhesive agent 13 is coated on one side of the PET sheet 11, not shown. On this adhesive agent 13, the workpiece fixing agent 12, the thickness of which is, for example, 1 μm to 1 mm, is coated. In the case of the acrylic adhesive 13, it may be bridged by the irradiation of heat or ultraviolet rays. If bridging is not conducted, the coating material (the workpiece fixing agent 12) and the adhesive agent 13 are mixed with each other. Therefore, it is impossible to attain a target function. When bridging is conducted, the coating material (the workpiece fixing agent 12) can be strongly fixed. Therefore, it becomes possible to exhibit the target function.

The present inventors investigated the peeling strength of T-peeling of the workpiece fixing sheet 10 composed as described above. T-peeling is described as follows. After the workpiece fixing agent 12 of the workpiece fixing sheet 10 has been heated, fused and stuck onto a fixing base, the workpiece fixing sheet 10 is peeled off from its end portion. This peeling is referred to as T-peeling. The peeling strength of T-peeling is a force needed for peeling the workpiece fixing sheet 10 from the fixing base.

The present inventors made investigation into the peeling strength of T-peeling described above with respect to the workpiece fixing sheet 10, on which the adhesive agent 13 was not provided, and also with respect to the workpiece fixing sheet 10, on which the adhesive agent 13 was provided. As a result of the investigation, the peeling strength of T-peeling of the workpiece fixing sheet 10, on which the adhesive agent 13 was not provided, was 0.1 N. On the other hand, the peeling strength of T-peeling of the workpiece fixing sheet 10, on which the adhesive agent 13 was provided, was 0.2 N to 10 N. From the result of the above investigation, it can be understood that the adhesive agent 13 makes the PET sheet 11 strongly adhere to the workpiece fixing agent 12.

As shown in the present embodiment, in the case of using the workpiece fixing sheet 10 on which the adhesive agent 13 is provided between the PET sheet 11 and the workpiece fixing agent 12, at the time of fixing a workpiece to the workpiece fixing agent 12, heating is conducted at a temperature at which only the workpiece fixing agent 12 is fused. At the time of peeling the workpiece from the workpiece fixing agent 12, hot water, at the temperature of which-only the workpiece fixing agent 12 is fused, is poured onto the workpiece and the workpiece fixing agent 12, so that the workpiece can be peeled off from the workpiece fixing sheet 10. In this connection, even when heating is conducted at a temperature at which only the workpiece fixing agent 12 is fused, the workpiece can be removed.

As explained above, the adhesive agent 13 is coated on one side of the PET sheet 11 and the workpiece fixing agent 12 is coated on this adhesive agent 13. Due to the foregoing, an adhesion force of the PET sheet 11 to the adhesive agent 13 can be enhanced. Accordingly, it is possible to prevent the workpiece fixing agent 12 from being peeled off from the PET sheet 11.

Next, the fifth embodiment will be explained below. In the present embodiment, only different points from those of the fourth embodiment described before will be explained. The present embodiment is characterized in that hot-melt material is used instead of the adhesive agent 13 used in the fourth embodiment.

That is, instead of the adhesive agent 13 shown in FIGS. 8A and 8B, the hot-melt material is used. A function of the hot-melt material is the same as that of the adhesive agent 13. In the present embodiment, rosin or epoxy resin is used for the hot-melt material.

After the above hot-melt material- has been heated and fused, it is coated on the PET sheet 11 and then cooled and solidified. After that, the workpiece fixing agent 12 is coated on the hot-melt material. In this way, the same workpiece fixing sheet as that shown in FIGS. 8A and 8B is formed.

In this connection, investigations were made into the same peeling strength of T-peeling as that of the fourth embodiment. As a result, the same peeling strength as that of the fourth embodiment was obtained.

In the present embodiment, at the time of fixing a workpiece to the workpiece fixing agent 12, heating is conducted at a temperature at which only the workpiece fixing agent 12 is fused. At the time of peeling the workpiece from the workpiece fixing agent 12, hot water, at a temperature at which only the workpiece fixing agent 12 is fused, is poured onto the workpiece and the workpiece fixing agent 12, so that the workpiece can be peeled off from the workpiece fixing sheet 10.

As explained above, the hot-melt material can be used for strongly fixing the workpiece fixing agent 12 onto the PET sheet 11.

Next, the sixth embodiment will be explained below. After an acrylic adhesive agent is coated on a PET sheet, a hot-type workpiece fixing agent 12, which fuses e.g. at 72° C. or 85° C., is coated on the acrylic adhesive agent. Moreover, a workpiece fixing agent 14, which fuses e.g. at 53° C. or 55° C., is coated on the workpiece fixing agent 12.

In this case, as the adhesive agent 13, an adhesive agent 13 is not preferably to transform due to heat generated when a workpiece fixing agent 12 at 72° C. or 86° C. is coated on the adhesive agent 13. In this connection, when a low-temperature-type workpiece fixing agent 14 is coated, an underlying high-temperature-type workpiece fixing agent 12 will not transform or fuse. In the case where the difference between the fusion start temperatures of the fixing agents 12 and 14 is the same as or more than 15° C., when a low-temperature-type workpiece fixing agent 14 is coated, a high temperature-type workpiece fixing agent 12 will not fuse so that a low-temperature-type workpiece fixing agent 14 can be finely coated.

In this connection, the natures of each agent 12, 14 are as follows.

(A) Low-Temperature-Type Workpiece Fixing Agent 14 <53° C.>

The fusion start temperature is 52.5° C., which is that of the composition (2). The fusion end temperature is 53.7° C.

<55° C.>

The fusion start temperature is 54.6° C., which is that of the composition (3). The fusion end temperature is 55.6° C.

(B) High-Temperature-Type Workpiece Fixing Agent 12) <72° C.>

The fusion start temperature is 72.1° C., which is that of the composition (4). The fusion end temperature is 73.4° C.

<86° C.>

The fusion start temperature is 86.2° C., which is that of the composition (5). The fusion end temperature is 87.9° C.

The technical advantageous effect of combining the agents 12 and 14 in the present embodiment is described below.

To assume that a workpiece being adhered is worked, when the workpiece is removed from a PET sheet 11 after a work process, the PET sheet 11 can be removed by pouring a hot water at a temperature wherein only a workpiece fixing agent fuses. However, depending on circumstances, an acryl resin constituting the adhesive agent 13 can be adhered to the workpiece or be mixed with the workpiece.

On the other hand, according to the present embodiment, as a low-temperature-type workpiece fixing agent 14 is coated on the side abutting against the workpiece and a high-temperature-type workpiece fixing agent 12 is coated on the side abutting against the adhesive agent 13, the low-temperature-type workpiece fixing agent 14 fuses and the high-temperature-type workpiece fixing agent 12 does not fuse by pouring a hot water at a temperature where the low-temperature-type workpiece fixing agent 14 fuses and the high-temperature-type workpiece fixing agent 12 does not fuse.

Accordingly, as the adhesive agent 13 is coated with the high-temperature-type workpiece fixing agent 12, components constituting the adhesive agent 13, that is, an acrylic resin in this embodiment, is prevented from being adhered to a workpiece or mixed with the workpiece. In particular, in the case where Si semiconductors or various sensors, which are extremely vulnerable to impure substances, are used, it is preferable to use the workpiece fixing jig with lamination-type workpiece fixing agents as in this embodiment.

Finally, another embodiment will be explained below. In the above embodiment, the base body includes a PET sheet 11 on which the workpiece fixing agent 12 is coated. However, the base body is not limited to a PET sheet. It is possible to use cloth, paper, hemp cloth, non-woven fabric, metallic foil or a metallic sheet as a base body on which the workpiece fixing agent 12 is coated so that it can be used as a jig for fixing the workpiece 40.

The above size of the workpiece fixing sheet 10 is an example but any size may be adopted. That is, after the workpiece fixing agent 12 has been coated on a PET sheet 11, the PET sheet 11 may be cut-by the size corresponding to the desired size of the workpiece. It is possible that the workpiece fixing sheet 10 is not cut but, for example, it is formed into a roll-shape.

A principal component of the above workpiece fixing agent 12 is paraffin. However, it is possible to use a workpiece fixing agent, the principal component of which is polyethylene glycol.

In the above workpiece fixing sheet 10, only one side of the PET sheet 11 is coated with the workpiece fixing agent 12. However, both sides of the PET sheet 11 may be coated with the workpiece fixing agent 12.

In the third embodiment described above, the PET sheet 11 includes the grooves 11a, the shape of which is a grate-shape, a wave-shape or an oblique-line-shape. However, the shape of the grooves 11a is not limited to the above specific shapes. For example, the shape of the grooves 11a may be formed into a linear-line-shape, a curved-line-shape, a dotted-shape, a wave-shape, a cross-shape (for example, a grate-shape), an oblique-cross-shape (for example, an oblique line-shape) or a shape in which shapes in three directions are put on each other. In the case of forming the grooves 11a, it is possible to use sand paper and also a knife and others.

It is possible to coat the adhesive agent 13 and the hot-melt material shown in the fourth and the fifth embodiment onto the PET sheet 11 on which the grooves 11a are formed as shown in the third embodiment. That is, on the PET sheet 11, the above adhesive agent 13 and the hot-melt material may be coated so that the grooves 11a can be filled.

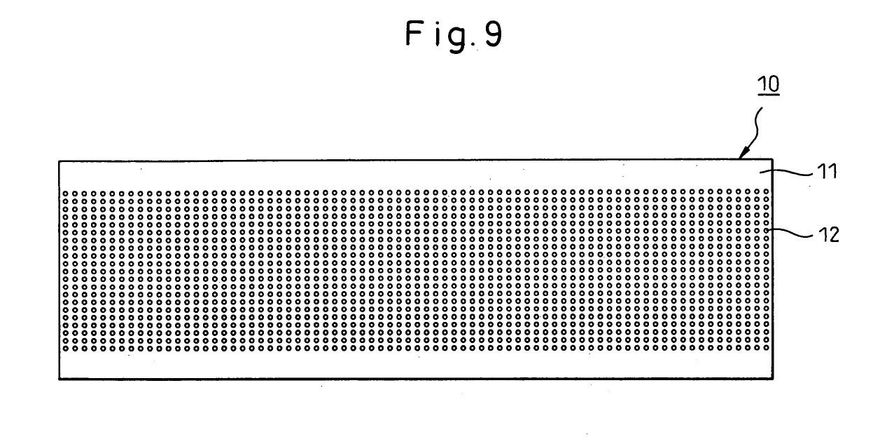

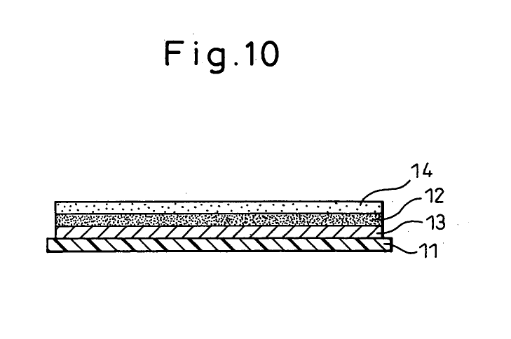

In the case of coating the workpiece fixing agent 12 on the PET sheet 11, the workpiece fixing agent 12, which has been fused, is injected from the nozzle 23. However, it is possible to manufacture the workpiece fixing sheet 10 by a method of printing the workpiece fixing agent 12 onto the PET sheet 11. In this case, as shown in FIG. 9, it is possible to coat the workpiece fixing agent 12, which is formed into a dot-shape, onto the PET sheet 11. The size and shape of the dot can be freely designed.

A coating pattern of the workpiece fixing agent 12 is not limited to the above dot or stripe. For example, the coating pattern of the workpiece fixing agent 12 may be a net pattern, an oblique-line pattern, a wave-line pattern-or a combination of them. The thickness of the workpiece fixing agent 12 may not be uniform on the PET sheet 11.

In the embodiments described above, the PET sheet 11 is wound around the rollers 21, 22 so as to form the workpiece fixing sheet 10. However, at the time of manufacturing the workpiece fixing sheet 10, the rollers 21, 22 need not be used. For example, when the workpiece fixing agent 12, which has been fused, is coated (or printed) on a surface of the PET sheet 11 which has been cut into a predetermined size, the workpiece fixing sheet 10 may be formed. In the case where the base body is not like a PET sheet 11, that is, in the case where the base body is not a sheet-shape, it is possible to form a workpiece fixing jig for fixing a workpiece by a method of directly spraying the workpiece fixing agent, which has been fused, onto the base body.

While the invention has been described by reference to specific embodiments chosen for purposes of illustration, it should be apparent that numerous modifications could be made thereto by those skilled in the art without departing from the basic concept and scope of the invention.

1. A workpiece fixing jig comprising:
a base body; and
a workpiece fixing agent coated on the base body, for fixing a workpiece when the workpiece fixing agent is fused and coagulated according to a temperature, wherein
a difference between a fusion start temperature and a fusion end temperature of the workpiece fixing agent is not more than 5° C.

2. A workpiece fixing jig according to claim 1, wherein the fusion start temperature and the fusion end temperature of the workpiece fixing agent are in a range from 18° C. to 100° C.

3. A workpiece fixing jig according to claim 1, wherein a principal component of the workpiece fixing agent is paraffin or polyethylene glycol.

4. A workpiece fixing jig according to claim 1, wherein the base body is made of plastic and formed into a sheet-shape, and the workpiece fixing agent is coated on one side or both sides of the sheet.

5. A workpiece fixing jig according to claim 4, wherein grooves are provided on the sheet-shaped base body, and the workpiece fixing agent is coated on the sheet-shaped base body so that the grooves can be filled with the workpiece fixing agent.

6. A workpiece fixing jig according to claim 4, wherein an adhesive agent is provided between the sheet-shaped body and the workpiece fixing agent.

7. A workpiece fixing jig according to claim 4, wherein a hot-melt material is provided between the sheet-shaped body and the workpiece fixing agent.

8. A workpiece fixing jig according to claim 1, wherein inorganic powder material is dispersed in the workpiece fixing agent.

9. A workpiece fixing jig according to claim 8, wherein the inorganic powder material is at least one selected from a group including alumina, carbon, iron, stainless steel, silicon S carbide, silicon and silicon nitride.

10. A working method in which a workpiece fixing jig is used,
the workpiece fixing jig comprising:
a base body; and
a workpiece fixing agent coated on the base body, for fixing a workpiece when the workpiece fixing agent is fused and coagulated according to a temperature, wherein
a difference between a fusion start temperature and a fusion end temperature of the workpiece fixing agent is not more than 5° C.,
the working method comprising:
a step in which the workpiece is put on the workpiece fixing jig and the workpiece fixing jig is heated to the fusion end temperature so as to fuse the workpiece fixing agent;
a step in which a temperature of the workpiece fixing jig is decreased to be lower than the fusion start temperature so as to coagulate the workpiece fixing agent;
a step in which the workpiece is worked; and
a step in which the workpiece fixing jig is heated to the fusion end temperature and the workpiece is removed from the workpiece fixing jig.

11. A working method according to claim 10, wherein a workpiece fixing agent, the fusion start temperature and the fusion end temperature of which are in a range from 18° C. to 100° C., is used.

12. A working method according to claim 10, wherein a workpiece fixing agent is used, the principal component of which is paraffin or polyethylene glycol.

13. A working method according to claim 10, wherein a base body, which is made of plastic and formed into a sheet-shape, is used and the workpiece fixing agent is coated on one side or both sides of the sheet.

14. A working method according to claim 13, wherein a sheet-shaped base body is used, in which grooves are provided, and the workpiece fixing agent is coated on the sheet-shaped base body so that the grooves can be filled with the workpiece fixing agent.

15. A working method according to claim 13, wherein a workpiece fixing jig is used, in which an adhesive agent is provided between the sheet-shaped base body and the workpiece fixing agent.

16. A working method according to claim 13, wherein a workpiece fixing jig is used, in which a hot-melt material is provided between the sheet-shaped base body and the workpiece fixing agent.
